(19) United States
(12) Patent Application Publication
(10) Pub. No.: US 2011/0296511 A1
(43) Pub. Date: Dec. 1, 2011

(54) Secure Fax with Passcode and Recipient Notification

(75) Inventors: Sahadevasangary Gajadevasangary, Stevenage (GB); Martin Roantree, Brookmans Park (GB); Alex Cheshire, St. Albans (GB)

(73) Assignee: Xerox Corporation, Norwalk, CT (US)

(21) Appl. No.: 12/789,548

(22) Filed: May 28, 2010

(51) Int. Cl. G06F 15/00; G06F 21/00; H04L 9/32

(52) U.S. Cl. 726/7; 358/1.15

(57) ABSTRACT

A system and a method of processing faxes are disclosed. The method includes receiving page(s) to be transmitted by a first fax device coupled to a fax transmission network. An address of a recipient is encoded in a field of a fax transmission. The fax transmission, including the page(s) and the encoded recipient address, is transmitted to a second fax device. The received page(s) of the fax are stored at the second fax device and a passcode is generated. The fax is not released for printing until the passcode is submitted to the second fax device.

### BACKGROUND

The embodiments described herein relate generally to facsimile machines, also known as fax machines, or multifunction machines which incorporate them, and more particularly to a system and method of processing incoming and outgoing faxes.

Faxing information has proven to be a simple and useful way of sending the information across long distances, while ensuring the integrity of the information being sent. As a result, a large number of faxes are sent and received daily. Each fax contains the information to be printed by the receiving fax device (the image data) as well as address information which the user, or the fax device itself, can enter in various prescribed fields. In addition to a field which is used to uniquely identify the receiving fax device (e.g., by its telephone number) other fields are also provided. These sub-address fields allow, for example, the sender to specify a destination sub-address box at the receiving fax device where the incoming fax will be stored or to send a password for accessing the fax at the receiving fax device. The use of the sub-address fields is optional and thus they are generally left empty.

An Internet facsimile (I-Fax) apparatus is one example of a fax device and is provided with functions of converting image data to a file and transmitting/receiving it over a computer network, a typical example of which is the Internet. The Internet facsimile apparatus is capable of carrying out usual facsimile communications over a Public Switched Telephone Network (PSTN), and therefore it also can function as apparatus connected between a computer network and PSTN.

It is known that fax communications, like all technologies, have security risks. This can be resolved by establishing policies around the use of fax machines. The level of fax security is built on the foundation of effective policies and procedures which govern their use. By creating a set of standard operating procedures (SOP) around the use of secure faxes, most of the threats involved can be mitigated. The most notable of fax issues is that the fax document will sometimes not reach its intended destination or if it does, may be seen by other than its intended recipient. As a result, the level of security and assurance of integrity for the fax transmission can be ineffective.

Thus, it is desirable therefore to establish a fax protocol that maintains the integrity and confidentiality of information transmitted by the fax transmission.

### INCORPORATION BY REFERENCE

The following references, the disclosures of which are incorporated herein in their entireties by reference, are mentioned:

U.S. Patent Application Publication No. 2004/0051899, entitled IMAGE PROCESSING DEVICE AND AUTOMATIC PRINTING RESTRICTION AND CONTROL METHOD AND DOCUMENT RECEPTION CONTROL METHOD, published on Mar. 18, 2004, to Saitoh, et al., discloses an automatic printing restriction and control method for an image processing device that comprises a facsimile communication unit capable of handling plural communication methods including facsimile communications via Internet, and prints out documents received by the facsimile communication unit. The method includes presetting whether or not automatic printing of received documents is to be implemented, separately with respect to each of the plural communication methods, and restricting and controlling implementation of automatic printing of received documents in accordance with the settings.

U.S. Patent Application Publication No. 2009/0083366, entitled SECURE DOCUMENT TRANSMISSION, published on Mar. 26, 2009, to Roantree, et al., discloses a method and apparatus which transmits an item that is in electronic form over multiple networks. The method begins by receiving the item that is to be electronically transmitted. The method separates the item into at least a first fragment and a second fragment, transmits the first fragment over a first network to a receiving device, and transmits the second fragment over a second network to the receiving device. After the receiving device receives all the different fragments, it combines the first fragment and the second fragment to reproduce the item.

U.S. Patent Application Publication No. 2009/0086277, entitled METHOD AND APPARATUS OF ADDING PAGES TO AN IMAGE DATA FILE TO BE SENT OVER A NETWORK, published on Apr. 2, 2009, to Cheshire, et al., discloses sending an image data file over a network. An image data file that includes a plurality of pages is sent from a first device to a second device, wherein at least one substitute or additional page of image data may be included in the image data file.

U.S. Pat. No. 7,623,257, entitled METHOD FOR HANDLING FAXES BY A FAX MACHINE, which issued Nov. 24, 2009, to Chase, et al., discloses a method of handling faxes by a fax machine. The method includes generating user-configured rules, each user-configured rule including a corresponding fax job condition and an associated fax machine action to be performed if the corresponding fax job condition is met. A user-configured policy is generated for handling faxes in a fax job including the user selecting the user-configured rules to be applied when the user-configured policy is applied and the user ranking the user-configured rules from a highest rank to a lowest rank. A fax machine receives a fax job and applies the user-configured policy to the fax job by applying the user-configured rules in an order of application from the highest ranked rule to the lowest ranked rule.

### BRIEF DESCRIPTION

In accordance with one aspect of the embodiments described herein, there is provided a method of processing secure faxes that includes receiving at least one page to be transmitted by a first fax device coupled to a fax transmission network. An address of a recipient is encoded in a field of a fax transmission. The fax, including the at least one page and the recipient address, is transmitted to a second fax device coupled to the network. The received at least one page of the fax is stored at the second fax device. A passcode is generated for releasing the received at least one page of the fax and is transmitted to the recipient address.

In accordance with another aspect of the embodiments described herein, a system for processing secure faxes includes a first fax device coupled to a fax transmission network. The first fax device includes memory for receiving at least one page to be transmitted by the first fax device. An encoder component is configured to encode information corresponding to an address of a recipient in a field of a fax transmission. When the fax transmission that includes the at least one page and the recipient address is transmitted to a second fax device coupled to a fax transmission network, the at least one page is securely stored until a passcode provided to the recipient address is submitted to the second fax device.

In accordance with another aspect of the embodiments described herein, a method of processing secure faxes includes receiving at least one page to be transmitted by a first fax device coupled to a fax transmission network. An encoded address of a recipient in at least one sub-address field of the fax transmission is decoded. The fax machine holds the at least one page until the passcode is submitted. If submitted, the at least one page is printed.

### BRIEF DESCRIPTION OF THE DRAWINGS

FIG. 1 is a diagrammatic view of a system including a first fax device connected by a fax transmission network to a second fax device;

FIG. 2 illustrates aspects of the system of FIG. 1 in greater detail; and

FIG. 3 is a flow chart illustrating a method for processing fax jobs in accordance with another embodiment.

### DETAILED DESCRIPTION

Embodiments herein provide systems and methods for encoding information in a fax transmission and generating a passcode which enables a receiving fax device to store the incoming fax transmission securely. The information, which may include the address of a recipient, e.g., an email address, a telephone number to which an SMS message can be sent, or the like, which is different from that of the fax device to which the fax is being transmitted, can be encoded in one or more sub-address fields. The fields may be provided as part of a T.30 protocol to support transmission of information to a receiving fax device. Additional information which may also be encoded may include the number of pages being sent, and/or sender identification information. The passcode can be generated using a predetermined algorithm and can be, for example, an alphanumeric code comprising a set of, for example, at least four or five characters. The fax transmission, including the at least one page and the recipient destination address, is transmitted to a second fax device where transmitted pages are securely stored until the passcode, that is provided to the recipient address, is submitted to the second fax device.

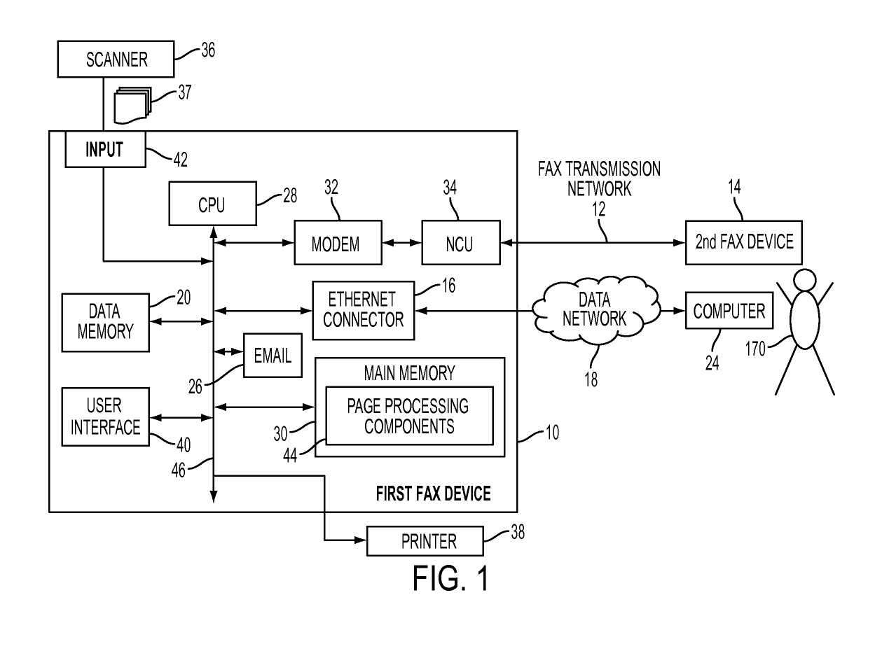

Referring to the drawings, FIG. 1 is a schematic depiction of a fax system which includes a first fax device 10. The first fax device 10 is connected to a fax transmission network (FTN) 12, for sending image data in the form of a facsimile (fax), to one or more other (second) fax device(s) 14 via the FTN 12. FTN 12 can be, for example, a Public Switched Telephone Network (PSTN), a Fax over Internet Protocol (FoIP), or other network suitable for transmission of faxes. The process of sending and/or receiving faxes is referred to herein as a fax job.

The first fax device 10 may also include a network connection 16, such as an Ethernet connection, for connecting the machine to a data transmission network 18. The network 18 may be a digital network such as a local area network (LAN), a wide area network (WAN), the Internet or Internet Protocol (IP) network, broadband networks, e.g., PSTN with broadband technology, VoiceOver IP, WiFi network, other networks or systems, or a combination of networks and/or systems.

The first fax device 10 includes data memory 20, for storing incoming faxes and for storing image data files which are to be transmitted via fax.

The fax device 10, 14 can include email functionality 26 for sending email messages to remote computers 24, such as personal computers, via the data network 18. An electronic form of faxes can be sent over the data network 18, for example, by compressing the fax image data, converting it to a TIFF file and text-coding the TIFF file, then adding it to the data section of e-mail in accordance with such as MIME (Multipurpose Internet Mail Extensions) and transmitting/receiving it as an e-mail.

The first fax device 10 includes a digital processor 28, such as a Central Processing Unit (CPU), for controlling the functionality of the fax device in a centralized manner, including handling fax jobs in the manner as described herein. The digital processor 28 can be variously embodied, such as by a single-core processor, a dual-core processor (or more generally by a multiple-core processor), a digital processor and cooperating math coprocessor, a digital controller, or the like.

The first fax device 10 also includes memory 30 for storing the programming suitable for carrying out fax job functions. The memories 20, 30 may represent any type of tangible computer readable medium such as random access memory (RAM), read only memory (ROM), magnetic disk or tape, optical disk, flash memory, or holographic memory. In one embodiment, the memory 30 may include a combination of random access memory and read only memory. In some embodiments, the processor 28 and memory 30 may be combined in a single chip.

The first fax device 10 also includes a modem 32 or other device suitable for connecting to the FTN 12 for sending and receiving faxes. The modem 32 is operable for modulating and demodulating a facsimile protocol signal and image signal. In the case of a PSTN network 12, a Network Coupler Unit (NCU) 34 may connect the fax device 10 to a telephone line to make an outgoing call to and receive an incoming call from a phone line in the PSTN 12 and to interface analog signals. In FoIP network, the NCU 34 is not required.

A source 36 of image data 37 is in communication with the first fax device. For example first fax device 10 can include or communicate with a scanner 36 for scanning documents to form electronic representations of the images thereof which can be sent in the form of faxes in a fax job. It is to be appreciated that the image data can be input from any suitable image source 36, such as a workstation, database, memory storage device, such as a disk, or the like. Typically each input digital image page includes image data for an array of pixels forming the image.

The first fax device 10 can also include or communicate with a printer 38 for forming printed images of received faxes, among other things, on sheet material such as paper. Suitable printers include electro-photographic printers, ink-jet printers, including solid ink printers, thermal head printers that are used in conjunction with heat sensitive paper, and other devices capable of marking an image on a substrate.

The first fax device 10 may also include a user interface 40 which can include a display screen and a control panel that enable a user to operate the fax device. The user interface 40 may provide a Graphic User Interface (GUI) displayable on the screen. The user interface 40 can be used to program the functionality of the fax device for processing faxes in the manner as described below. In other embodiments, the fax device may also be operated or programmed remotely via computer 24 connected to the fax device 12 by the data network 18.

The first fax device 10 includes an input device 42, which is configured to receive an image data file from source 36. As an alternative to a scanner, the image data can be input from any suitable image source 36, such as a workstation, database, memory storage device, such as a disk, or the like. Typically, each input digital image includes image data for an array of pixels forming the image. The image data may be photographs, video images, combined images which include photographs along with text, and/or graphics, or the like. The image data may be received in JPEG, GIF, JBIG, BMP, TIFF or other common filed format used for images and which may optionally be converted to another suitable format prior to processing. In an exemplary embodiment, the image data file comprises a plurality of pages to be transmitted by the first fax device 10.

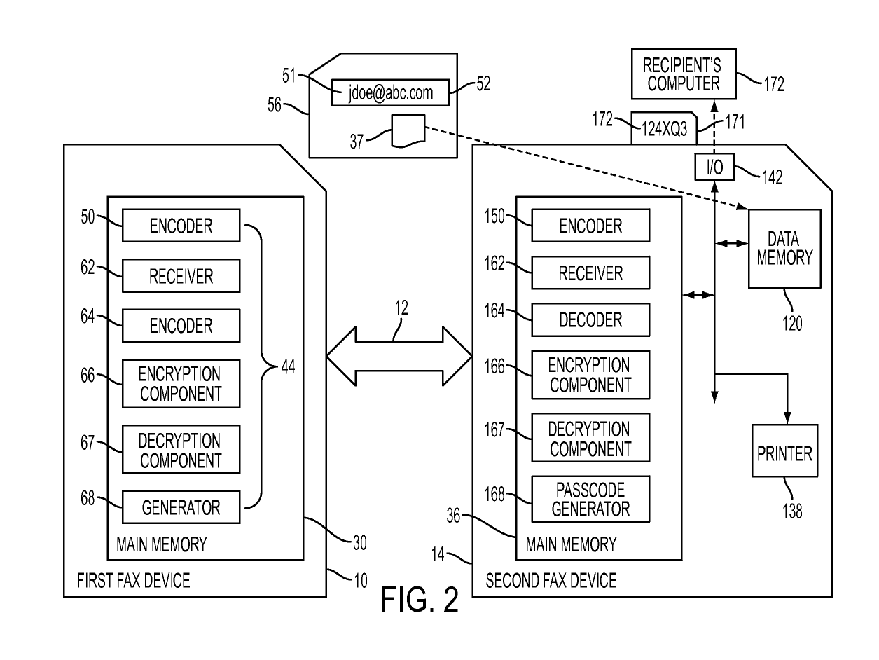

The fax device 10 includes fax securing components 44, for implementing the methods described herein and which may be implemented in hardware or a combination of hardware and software. In the embodiment illustrated in FIG. 1, the components 44 are in the form of software instructions stored in memory 30, which are executed by processor 28. These components 44 are described in greater detail with reference to FIG. 2.

The various components 16, 20, 26, 28, 30, 32, 34, 48, 40, 42 of the fax device 10 may communicate via a data/control bus 46.

The second fax device 14 may be similarly configured to the first device. However, in some embodiments, the devices 10, 14 may be somewhat different. For example, the first fax device may be configured for sending but not receiving faxes. Additionally, the components 44 need not be identical.

Fax or facsimile machines disclosed herein are merely exemplary and embodiments of the disclosure may be practiced with other systems having fax capabilities (e.g., a computer, a fax server/gateway, personal digital assistant (PDA), cell phone, etc.). In addition, in an embodiment, the fax devices or first device 10 may comprise or may be part of another machine or device such as a multifunction printing device MFP or MFD) that includes multiple capabilities such as printing, scanning, faxing, and/or copying. In an embodiment, first device 10 may comprise a PC, or other device for sending and receiving faxes. Other machines and devices may also be used as long as they are capable of handling electronic image data.

The fax transmission protocol used can be any standard protocol. The International Telecommunication Union Telecommunications Standardization Sector (ITU or ITU-T), based in Geneva, Switzerland, coordinates telecommunication standards and protocols, including facsimile transmission. The ITU, for example, identifies the standards, characteristics, and operation for facsimile devices of Group 3 and Group 4 digital transmission. Group 3 (G3) fax technology is currently the most widely used type of facsimile transmission. In general, G3 fax technology uses digital modulation combined with amplitude and phase modulation of an analog signal (generated by modems). Typically data is compressed using digital compression methods and encoding is then used to communicate image data over analog telephone lines with a result of a reduced transmission time of less than one minute per page. Group 4 (G4) faxes are designed to operate over digital circuits; specifically, G4 operates on a 64 Kbps ISDN (Integrated Services Digital Network) B Channel. Unlike Group 3 faxes, the digital scan information if not converted into an analog signal, rather it is transmitted digitally.

FIG. 2 illustrates aspects of the exemplary system for processing secure faxes. In particular, the components 44 are shown, and some of the components of the devices 10, 14 shown in FIG. 1 are omitted for clarity. Similar components of the second fax device 14 are accorded the same numbers as for the first fax device, incremented by 100.

The first fax device 10 includes an encoder component 50, which is configured to encode information for enabling the second fax machine to recognize that the fax transmission is intended for a recipient whose address is encoded in the transmission. The second fax device 14 can include an analogous encoder component 150. The information to be encoded may include an address of a recipient. For example, an Internet Routing Address (IRA), i.e. email address 51 is encoded in a field 52 of a fax transmission 56. The encoder component 50 may also be configured to encode other information in the fields of the fax transmission as disclosed in copending U.S. application Ser. No. 12/789,511, filed contemporaneously herewith on May 28, 2010 and entitled BROKEN FAX DOCUMENT RECOMBINING SYSTEM. The encoder component 50 may convert signals, T.30 data, and high-speed data for transmission over the network 12.

The field 52 used for the encoding may be a sub-address field(s). In an exemplary embodiment, the sub-address field(s) 52 is at least one of a Internet Routing Address (IRA) field and a Selective Polling (SEP) field which can support identification information and can contain up to 20 digits. Rather than using them for their intended purpose, such as encoding a password or other parameters, the field 52 is used to encode a recipient address. In one embodiment, the full email address is encoded. In another embodiment, sufficient information for the second fax device to determine the email address is encoded.

Fax transmission 56 comprising the at least one page 37 and recipient address 51 encoded in field 52 is transmitted to the second fax device 14 coupled to the fax transmission network 12. The field information is sent ahead of the pages being transmitted, so that it arrives first at the second fax device 14. If the fax transmission is broken, the field information in field 52 is resent, along with the remaining pages. Thus, the sets of pages can be matched using a Job identifier encoded in one of the sub-address fields. This may allow for multiple faxes to the same final recipient.

The second fax device 14 includes a receiver component 162 configured to receive the at least one page 37 and recipient address in the fax transmission 56, and store the at least one page and recipient address in data memory 120.

Second fax device 14 may include a decoder component 164 configured to decode encoded information in the sub-address field(s) 52 of the fax transmission 156. The decoder 164 includes instructions for reading the information encoded in the sub-address field 52 and identifying therefrom, the address of the recipient. First fax device 10 can include a similar decoder component 64. The decoder is instructed to interpret the information or a portion thereof, in the field 52 as the recipient information and, where the information is present in the field, to place a hold on the faxed pages.

An encryption component 166 may be configured to encrypt the fax transmission 156 using an algorithm to make it unreadable. A corresponding decryption component 167 can decrypt the encrypted fax transmission 56. First fax device 10 can include a similar encryption component 66 and decryption component 67.

A passcode generator 168 is configured to generate a passcode 169 to protect the encrypted fax transmission 156 from being accessed by an unintended recipient. The passcode may be a one-time passcode unique to the particular fax transmission 156. The passcode can be generated using a predetermined algorithm. The algorithm may use the information provided encoded in the field 52 of the fax transmission 56, e.g. sending machine information, job ID, and destination address of recipient as a basis for computing a onetime passcode. Alternatively, a onetime passcode may be generated by a random number generator or the like. First fax device 10 can include a similar passcode generator 68.

Second fax device 14 may email the passcode and a fax transmission received notification to the email address of the intended recipient 170 as an email message 171. The recipient 170 is the person waiting to receive the secure fax. The recipient may receive the message 171 at any suitable message receiving device 172, such as his personal computer, a PDA, mobile phone, or the like. The recipient may then use the passcode to release the fax transmission 56 for printing on printer 138. For example, the recipient or his designee may enter the passcode to the fax device 14, e.g., using the user interface 40, to cause the fax to be printed. Or, the recipient 170 or his designee may send an authorization message to the second fax device which includes the passcode. Alternatively, the receiver 162 may enter the passcode to cause the fax to be printed.

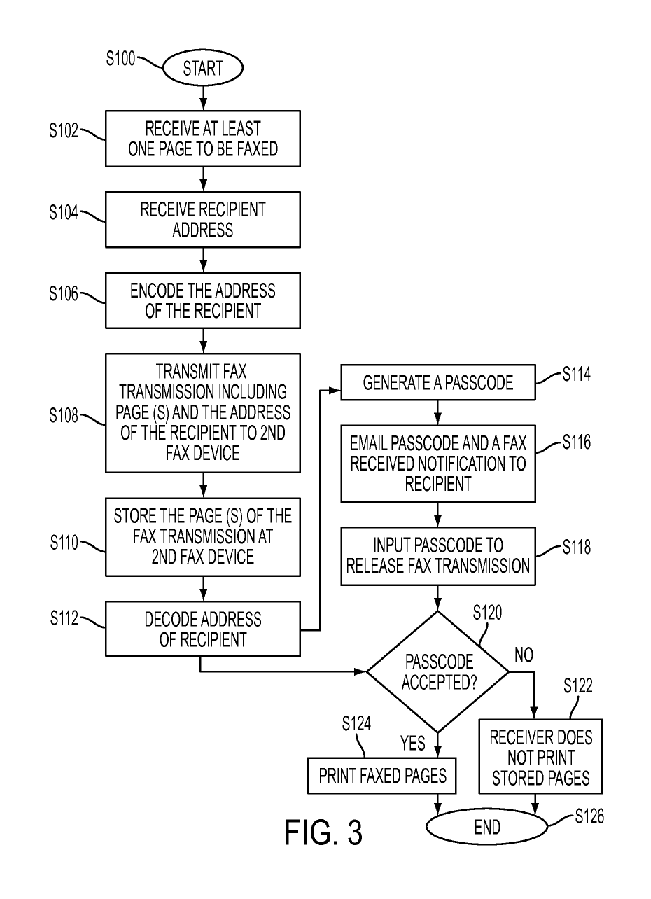

FIG. 3 is a flowchart illustrating a method of processing secure faxes in a system such as that shown in FIGS. 1 and 2. The method begins at S100. At S102, at least one page be transmitted, is received by the first fax device 10.

At S104, a user may be prompted to enter an address of an intended recipient. The user may also be prompted to enter address related information for a second fax device 14, such as its telephone number or IP address, to which the fax is to be transmitted.

At S106, the address of a recipient 170 is encoded in a field of the fax transmission 56. Page number information, e.g. number of pages, sender information, e.g. a job identification (job ID), may also be encoded for transmission in the fax transmission 56.

At S108, the fax transmission comprising the at least one page and address of the recipient is transmitted to the second fax device 14.

At S110, the fax transmission is received by the second fax device 14. When the field 52 includes information which the fax device recognizes as being a recipient address, the fax transmission is stored (e.g., in an encrypted form) in data memory 120.

At S112, the address of the recipient is decoded from the field 52 at the second fax device 14. The recipient address may be stored in memory. Additionally, the number of pages and sender ID may be decoded and associated with the address of the recipient.

At S114, a passcode to secure the fax transmission 156 is generated at the second fax device 14.

At S116, the passcode and a fax received notification may be emailed to the recipient's email address by the second fax device or otherwise sent to the recipient. The passcode may be a one-time passcode unique to the particular fax transmission 156. The one-time passcode may be transmitted to the address of the recipient on receipt of the completed fax transmission 156 by the second fax device 14.

At S118, the pages of the fax transmission are released for printing when the passcode is input. The recipient may be provided with a fixed number of attempts to enter the passcode correctly, after which the release of the fax may be blocked, at least temporarily.

At S120, if the passcode is accepted after input at 5116, the method proceeds to S124, otherwise, to S122.

At 5124 all pages of the fax transmission are printed on the printer 138.

The method ends at S126.

The method illustrated in FIG. 3 may be implemented in a computer program product that may be executed on a computer. The computer program product may be a tangible computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of processing a fax that is in turn capable of implementing the flowchart shown in FIG. 3, can be used to implement the method for processing faxes.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

It will be appreciated that variants of the above-disclosed and other features and functions, or alternatives thereof, may be combined into many other different systems or applications. Various presently unforeseen or unanticipated alternatives, modifications, variations, or improvements there in may be subsequently made by those skilled in the art which are also intended to encompassed by the following claims.

What is claimed is:

1. A method of processing secure faxes comprising:
receiving at least one page to be transmitted by a first fax device coupled to a fax transmission network;
encoding an address of a recipient in a field of a fax transmission;
transmitting the fax transmission comprising the at least one page and the recipient address to a second fax device coupled to the network;
storing the received at least one page of the fax at the second fax device;
generating a passcode for releasing the received at least one page of the fax transmission; and
transmitting the passcode to the recipient address.

2. The method of claim 1, wherein the field in which the recipient address is encoded is a sub-address field.

3. The method of claim 2, wherein the sub-address field is at least one of a password (PWD) field and a Selective Polling (SEP) field.

4. The method of claim 1, wherein the passcode is generated using a predetermined algorithm.

5. The method of claim 1, further comprising sending the at least one page to the address of the recipient.

6. The method of claim 1, wherein the passcode is a one-time passcode, the one-time passcode is transmitted to the recipient address upon receipt of a completed fax transmission by the second fax device.

7. The method of claim 1, further comprising preventing the at least one page from being printed before the transmitted passcode is input to the second fax device.

8. The method of claim 1, further comprising printing the at least one page on receipt of the input passcode.

9. The method of claim 1, wherein at least one of the first fax device and the second fax device comprises a multi-function device.

10. The method of claim 1, wherein the network is selected from the group consisting of a local area network (LAN), a wide area network (WAN), a fax over internet protocol (FoIP) network, a PSTN, a WiFi network, and a combination thereof.

11. The method of claim 1, wherein the encoding is performed by a processor of the first fax device.

12. The method of claim 1, wherein the generating is performed by a processor of the second fax device.

13. A computer program product comprising tangible media which encodes instructions for performing the method of claim 1.

14. A system for processing secure faxes comprising:
a first fax device coupled to a fax transmission network including:
memory for receiving at least one page to be transmitted by the first fax device; and
an encoder component configured to encode information, corresponding to an address of a recipient, in a field of a fax transmission, whereby when the fax transmission comprising at least one page and the recipient address is transmitted to a second fax device coupled to the fax transmission network, the at least one page is securely stored until a passcode provided to the recipient address is submitted to the second fax device.

15. The system of claim 14, wherein the encoder component is in the form of software instructions stored in memory and which are executed by a processor of the first fax device.

16. The system of claim 14, further comprising a second fax device coupled to the fax transmission network comprising a decoder component configured to decode the destination address of the recipient in the field of the fax transmission and instruct the fax machine to hold the at least one page until the passcode is submitted.

17. The system of claim 14, wherein at least one of the first fax device and the second fax device comprises a multi-function device.

18. The system of claim 14, further comprising a printer associated with the second fax device for printing the at least one page.

19. The system of claim 14, wherein the network is selected from the group consisting of a local area network (LAN), a wide area network (WAN), a fax over internet protocol (FoIP) network, a PSTN, a WiFi network, and a combination thereof.

20. A method of processing secure faxes comprising:
receiving at least one page transmitted over a fax transmission network;
decoding an address of a recipient encoded in at least one sub-address field of the fax transmission; and
holding the at least one page until the passcode is submitted, and if the passcode is submitted, printing the at least one page.

21. The method of claim 20, wherein the sub-address field is at least one of a password (PWD) and a Selective Polling (SEP) field.

22. The method of claim 20, further comprising:
encoding the address of a recipient in the sub-address field of the fax transmission; and
transmitting the fax transmission comprising the at least one page and encoded address to the fax device.

23. A computer program product comprising tangible media which encodes instructions for performing the method of claim 20.
